(19) United States
(12) Patent Application Publication
(10) Pub. No.: US 2017/0193460 A1
(43) Pub. Date: Jul. 6, 2017

(54) SYSTEMS AND METHODS FOR PREDICTING ASSET SPECIFIC SERVICE LIFE IN COMPONENTS

(71) Applicant: General Electric Company, Schenectady, NY (US)

(72) Inventors: Arun Karthi Subramaniyan, Cliffton Park, NY (US); K.M.K. Genghis Khan, Niskayuna, NY (US); Felipe Antonio Chegury Viana, Niskayuna, NY (US); Natarajan Chennimalai Kumar, Schenectady, NY (US)

(21) Appl. No.: 14/985,971

(22) Filed: Dec. 31, 2015

(51) Int. Cl. G06Q 10/00

(52) U.S. Cl. CPC G06Q 10/20

(57) ABSTRACT

A system for determining a decrease in service life to a target component is provided. The system includes a service life modeling (SLM) computing device, which identifies a physics variable for a test component. The SLM computing device generates a likelihood function for the physics variable. The SLM computing device applies probabilistic techniques to the physical measurements together with a set of coefficients. The SLM computing device generates a hybrid service life model for the test component. The SLM computing device calibrates the hybrid service life model. The SLM computing device applies the hybrid service life model to a target component that shares characteristics with the test component. The SLM computing device identifies a predictive metric for the target component. The SLM computing device outputs the metric. The SLM computing device directs an operator to modify a maintenance plan for the target component based on the metric.

### BACKGROUND

The field of the disclosure relates generally to methods for formulating an accurate service life model. More specifically, the present disclosure relates to probabilistic service life models and techniques with automatic built-in quality checks to ascertain model quality.

Any system, especially one involving specifically engineered components and/or a complex combination of parts, is subject to anticipated and potentially accelerated wear and a decrease in service life, including component failure. For example, an engine may be rendered inoperable, where a major subcomponent unexpectedly reaches the end of its service life. Other components simply deteriorate over time, e.g., brake pads on an automobile, eventually rendering them unusable. Component failure can result in significant financial loss. As such, a user of any component or system may wish to know when the component is likely to reach the end of its service life, or at least the degree of deterioration it is experiencing.

However, known models for predicting decreases in service life often are limited by techniques that require large datasets. For example, some known predictive models employ linear regression, or logarithmic regression. Component users frequently do not have a dataset large enough, i.e., sufficient numbers of parts at their end of service life that would enable the abovementioned techniques to provide reliable predictions. Often, users have only sparse datasets available to them. Accordingly, known models are unable to provide satisfactory predictability. Also, users are not able to determine with any precision the missing datasets that would improve predictability. Even where nontrivial data are available, large variability exists in the dataset, worsening predictability. Other non-linear data-driven approaches, e.g., Gaussian process modeling are similarly unable to extrapolate in time and even interpolate without having a large dataset as input.

### BRIEF DESCRIPTION

In one aspect, a system for determining a decrease in service life to a target component is provided. The system includes a service life modeling (SLM) computing device in communication with a memory device and a processor. The SLM computing device is configured to identify a physics variable for a test component, where the physics variable represents a measure of service life decrease. The SLM computing device is also configured to a set of physical measurements for the test component in the memory device. The SLM computing device is further configured to generate at least one likelihood function for the physics variable, where the SLM computing device is further configured to generate the at least one likelihood function by incorporating the physics variable. The SLM computing device is also configured to apply one or more probabilistic techniques to the set of physical measurements of the test component in conjunction with a set of coefficients, where each coefficient of the set of coefficients corresponds to at least one physical measurement of the set of physical measurements. The SLM computing device is further configured to generate a hybrid service life model for the test component, where the hybrid service life model is specific to the test component and where the hybrid service life model includes the at least one likelihood function. The SLM computing device is also configured to calibrate the hybrid service life model for the test component, based at least in part on an output of the one or more probabilistic techniques. The SLM computing device is further configured to apply the hybrid service life model to a target component that shares at least one characteristic with the test component. The SLM computing device is also configured to identify at least one predictive metric for a target component, based on the service life model, output the at least one predictive metric. The SLM computing device is further configured to direct an operator to initiate a logistics process to modify a maintenance plan for the target component at least partially based on the at least one predictive metric.

In another aspect, a method for determining a decrease in service life to a target component is provided. The method is implemented using a service life modeling (SLM) computing device in communication with a memory device and a processor. The method includes identifying, by the SLM computing device, a physics variable for a test component, where the physics variable represents a measure of service life decrease. The method includes storing a set of physical measurements for the test component in the memory device. The method also includes generating, by the SLM computing device, at least one likelihood function for the physics variable, where the SLM computing device is further configured to generate the at least one likelihood function by incorporating the physics variable. The method further includes applying, by the SLM computing device, one or more probabilistic techniques to the set of physical measurements of the test component in conjunction with a set of coefficients, where each coefficient of the set of coefficients corresponds to at least one physical measurement of the set of physical measurements. The method also includes generating, by the SLM computing device, a hybrid service life model for the test component, where the hybrid service life model is specific to the test component and where the hybrid service life model includes the at least one likelihood function. The method further includes calibrating, by the SLM computing device, the service life model for the test component, based at least in part on an output of the one or more probabilistic techniques. The method also includes applying, by the SLM computing device, the service life model to a target component that shares at least one characteristic with the test component. The method further includes identifying, by the SLM computing device, at least one predictive metric for a target component, based on the service life model. The method also includes outputting the at least one predictive metric. The method further includes directing, by the SLM computing device, an operator to initiate a logistics process to modify a maintenance plan for the target component at least partially based on the at least one predictive metric.

In yet another aspect, a computer readable medium that includes computer executable instructions for determining a decrease in service life to a target component is provided. When executed by a Service Life Modeling (SLM) computing device including a processor, the computer executable instructions cause the SLM computing device to identify a physics variable for a test component, where the physics variable represents a measure of service life decrease. The computer executable instructions also cause the SLM computing device to store a set of physical measurements for the test component within a memory device. The computer executable instructions further cause the SLM computing device to generate at least one likelihood function for the physics variable, where the SLM computing device is further configured to generate the at least one likelihood function by incorporating the physics variable. The computer executable instructions also cause the SLM computing device to apply one or more probabilistic techniques to the set of physical measurements of the test component in conjunction with a set of coefficients, where each coefficient of the set of coefficients corresponds to at least one physical measurement of the set of physical measurements. The computer executable instructions further cause the SLM computing device to generate a hybrid service life model for the test component, where the hybrid service life model is specific to the test component and where the hybrid service life model includes the at least one likelihood function. The computer executable instructions also cause the SLM computing device to calibrate the hybrid service life model for the test component, based at least in part on an output of the one or more probabilistic techniques. The computer executable instructions also cause the SLM computing device to apply the hybrid service life model to a target component that shares at least one characteristic with the test component. The computer executable instructions further cause the SLM computing device to identify at least one predictive metric for a target component, based on the service life model. The computer executable instructions also cause the SLM computing device to output the at least one predictive metric. The computer executable instructions further cause the SLM computing device to direct an operator to initiate a logistics process to modify a maintenance plan for the target component at least partially based on the at least one predictive metric.

### DRAWINGS

These and other features, aspects, and advantages will become better understood when the following detailed description is read with reference to the accompanying drawings in which like characters represent like parts throughout the drawings, where:

FIG. 1 is a simplified block diagram of an exemplary service life modeling (SLM) computing device coupled with other computing devices;

FIG. 2 is a simplified block diagram of an exemplary configuration of a server system, including the SLM computing device shown in FIG. 1;

FIG. 3 is an exemplary process flow showing how a service life decrease model is developed by the SLM computing device using test components;

FIG. 4 is a flowchart of an exemplary method of combining multiple likelihood functions into a single model that is developed for a particular component, using the SLM computing device shown in FIG. 1;

FIG. 5 illustrates a calibration process for a service life model using synthetic values for coefficients as received from a plurality of components;

FIG. 6 shows a plurality of exemplary graphs illustrating prediction values for a component over time;

FIG. 7 shows a plurality of exemplary graphs illustrating future predictive values for a component;

FIG. 8 shows an exemplary method for predicting decreases in a service life of components; and

FIG. 9 is an exemplary configuration of a database within SLM computing device 10, (shown in FIG. 1), along with other related computing components, that are used to predict service life decrease in a component.

Unless otherwise indicated, the drawings provided herein are meant to illustrate features of embodiments of the disclosure. These features are believed to be applicable in a wide variety of systems including one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “computer-readable media” includes all tangible, computer-readable media, including, without limitation, computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As used herein, the term “Bayesian inference” is used to denote a method of probabilistic inference in which Bayes' theorem is used to update the probability for a hypothesis as evidence is acquired.

Also, as used herein, the term “hybrid model” refers to a probabilistic model that combines physical measurement data (also referred to herein as “component data” and “component test data”) with notional data about how a component is supposed to operate, e.g., component limitations such as maximum operating temperature, component size, and the like.

Further, as used herein, the term “likelihood function” denotes a function of the parameters of a probabilistic model. That is, the likelihood of a set of parameter values, θ, given outcomes x, is equal to the probability of those observed outcomes given those parameter values.

As used herein, the terms “software” and “firmware” are interchangeable, and include any computer program stored in memory for execution by devices that include, without limitation, mobile devices, clusters, personal computers, workstations, clients, and servers.

Computer systems, such as the service life modeling computing device are described, and such computer systems include a processor and a memory. However, any processor in a computer device referred to herein may also refer to one or more processors where the processor may be in one computing device or a plurality of computing devices acting in parallel. Additionally, any memory in a computer device referred to may also refer to one or more memories, where the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.” The term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above are only examples, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The present disclosure relates to a Service Life Modeler (SLM) computing device that is used for modeling the predicted decrease in service life of a component. The SLM computing device predicts when a component approaches the end of its service life. More specifically, the SLM computing device is configured to apply a Bayesian inference framework to build physics-based hybrid lifing models. Bayesian inference provides the capability to combine physics knowledge and field data, and to account for uncertainty due to model form and measurement error. A physics-based lifing model differs from a traditional data-driven lifing model in that a physics-based model requires a much smaller dataset and is still able to provide a meaningful prediction of, for example, how an end of service life may be accelerated with the usage of a component. In addition, the physics-based models provide reliable forecasting capability that is not available in data-driven techniques. The SLM computing device is configured to develop an individualized model for every component and asset and leverage the collection of individualized models to make them predictive on a much broader set. The SLM computing device enables the development of probabilistic service life decrease models using a component's complete operational history and also the design intent behind use of the component. The SLM computing device creates a “hybrid” likelihood that combines: a) the physics of service life decrease, e.g., physics-based evaluations or equations providing knowledge of how a component's service life may decrease given specific circumstances; and b) actual inspections and observations in the field of the component while in use. The SLM computing device automatically checks its generated models for quality by comparing generated predictive data against actual data for the component or for similar components. The SLM computing device uses Bayesian and other inference methods (including but not limited to) to estimate model parameters by combining design data, operational data, data generated from its hybrid likelihood models and field inspection/observation of service life decrease. The SLM computing device is further configured to update the asset specific model coefficients when new observations become available and is also configured to automatically assess the quality of the model predictions.

In one embodiment, the SLM computing device uses a Bayesian hybrid modeling (BHM) framework to develop service life models. The BHM framework implements several algorithms including but not limited to an adaptive “Metropolis-within-Gibbs” algorithm. A standalone Markov chain Monte Carlo (MCMC) code is also used. The features of this standalone MCMC code include that: (1) users are allowed to directly set up constraints on model parameters, (2) users can construct a likelihood function using their own computer model, and (3) an intelligent search for step size can be performed by optimizing the acceptance ratio using burn-in samples. In the simplest case, components are measured, physical observations are recorded, and a graph may model the physical measurements. Similarly, a probability density function may model the physical measurements. However, engineered components contain multiple parts and commonly give rise to multiple physical observations that must be accounted for. The SLM computing device is configured to incorporate multiple physical measurements into a likelihood function that, in some embodiments, uses probability density functions, cumulative distribution functions, and the like, to generate predicted values for the physical measurements.

In at least some implementations, a decrease in service life is calculated as a function of observed physical measurements for the component in association with one or more coefficients. For example, service life decrease, e.g., and without limitation, crack size of an engine fan blade in a test component may be calculated as the sum of the ambient temperature and pressure on a component each multiplied by a certain coefficient, e.g., 0.1. However, observed deterioration in other components may correspond to coefficients of temperature and pressure that are not 0.1. Once a service life model is developed, the SLM computing device applies the model to a target component, e.g., and without limitation, by inputting physical measurements and other specifications of a target component to extrapolate the target component's service life decrease over time. In at least some implementations, the SLM computing device outputs a probability distribution for each coefficient, based on the BHM framework. These probability distributions provide a predictive metric for service life decrease in target components.

If modeling a target component requires data that is not available from the service life model developed using the test component, the SLM computing device is able to indicate the specific data points that would be required, or provide a certainty factor with its output, indicating a level of confidence in the model-based prediction, in light of the unavailable data. The SLM computing device also performs preprocessing on the test component data in order to account for outliers and reduce uncertainty in parameter prediction.

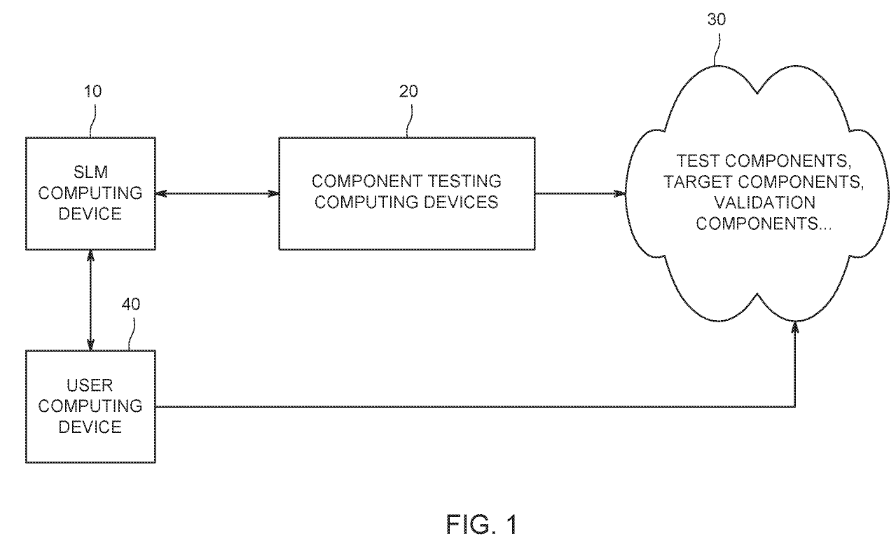

FIG. 1 is a simplified block diagram of an exemplary service life modeling (SLM) computing device coupled with other computing devices. SLM computing device 10 is in communication with one or more component testing computing devices 20, and at least one user computing device 40. Component testing computing devices 20 are also coupled to a plurality of components 30. In one embodiment, component testing computing devices 20 are embedded with various physical components including, and without limitation, engine computers, machine sensors, embedded processors, and the like. In another embodiment, such component testing computing devices 20 are separate from the actual component to be tested, but receive and record testing data for each component including, and without limitation, temperature data, crack length data, and the like. Components 30 include test components, i.e., those used to develop service life models, target components, i.e., those to which service life models are applied in order to issue predictions for the target components, and validation components, i.e., those that are used to validate the service life models.

In one embodiment, SLM computing device 10 receives component data from component testing computing devices 20 and develops service life models. User computing device 40 sends a prompt or signal to SLM computing device 10 to develop a service life model, request component data, or issue a prediction for a component. SLM computing device 10 develops and applies a service life model, generates predictions regarding the future service life of a component, and transmits the prediction(s) to user computing device 40.

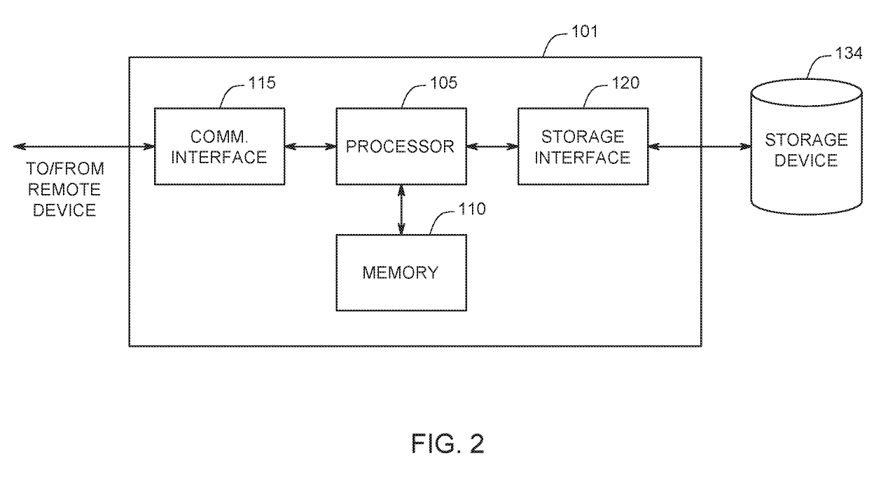

FIG. 2 is a simplified block diagram of an exemplary configuration of a server system, including SLM computing device 10 (shown in FIG. 1). Server system 101 includes a processor 105 for executing instructions. Instructions are stored in a memory area 110, for example. Processor 105 includes one or more processing units, e.g., and without limitation, in a multi-core configuration for executing instructions. The instructions may be executed within a variety of different operating systems on the server system 101, such as UNIX, LINUX, Microsoft Windows®, and the like. The algorithms can also be executed on massively parallel infrastructure such as Hadoop and Spark. More specifically, the instructions may cause various data manipulations on data stored in storage 134, e.g., and without limitation, create, read, update, and delete procedures. It should also be appreciated that upon initiation of a computer-based method, various instructions may be executed during initialization. Some operations may be required in order to perform one or more processes described herein, while other operations may be more general and/or specific to a particular programming language, e.g., and without limitation, C, C#, C++, Java, or other suitable programming languages, and the like.

Processor 105 is operatively coupled to a communication interface 115 such that server system 101 is capable of communicating with a remote device such as a user system or another server system 101. For example, communication interface 115 receives communications from user computing devices and test computing devices via the Internet.

Processor 105 is also operatively coupled to a storage device 134. Storage device 134 is any computer-operated hardware suitable for storing and/or retrieving data. In some embodiments, storage device 134 is integrated in server system 101. In other embodiments, storage device 134 is external to server system 101. For example, server system 101 may include one or more hard disk drives as storage device 134. In other embodiments, storage device 134 is external to server system 101 and may be accessed by a plurality of server systems 101. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 105 is operatively coupled to storage device 134 via a storage interface 120. Storage interface 120 is any component capable of providing processor 105 with access to storage device 134. Storage interface 120 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 105 with access to storage device 134.

Memory area 110 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

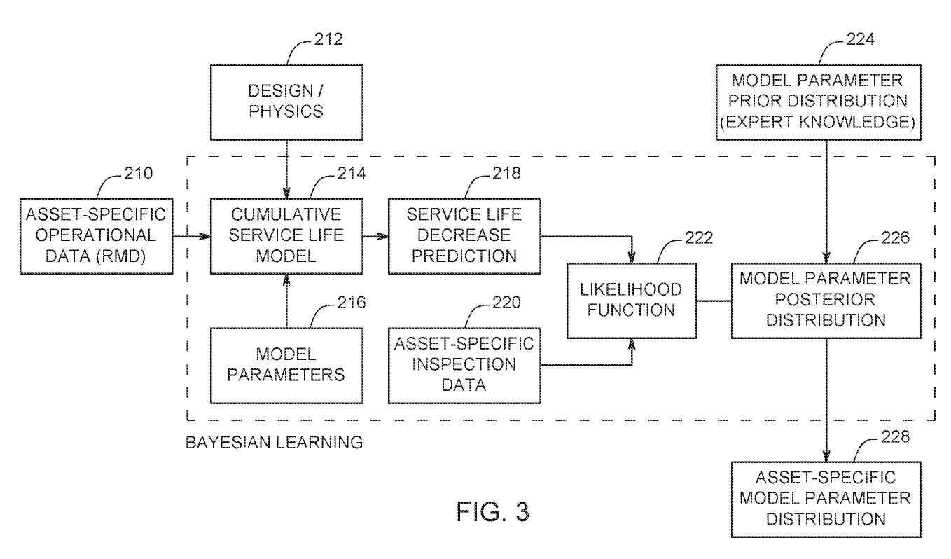

FIG. 3 is an exemplary process flow showing how a service life decrease model is developed by SLM computing device 10 (shown in FIG. 1) using test components, i.e., components with existing operational use and service life decrease that are used to build a model. The example of a fan blade for an aircraft engine will be used to illustrate the process flow. SLM computing device 10 receives remote monitoring and diagnostics (RMD) data 210 (also called asset specific operational data) and design data 212. In one embodiment, RMD data 210 refers to physical data generated by regular operation of the fan blade, e.g., and without limitation, operational temperature data, operational air pressure data, and the like. In one embodiment, design data 212 refers to design specifications such as dimensions, materials used for construction, maximum operating temperatures.

Both RMD data 210 and design data 212 are input into cumulative model 214. Model parameters 216 are also inherent to the cumulative model 214. Model parameters 216 refer to a selection of particular physical constants that will be the subject of the model, i.e., will be part of likelihood functions that are later generated. Model parameters 216 may include fan blade temperature coefficient, stress concentration, stress intensity factors, and the like. Inspection data 220 includes physical observations that indicate a degree of service life decrease to the component. Inspection data 220 may refer to observational data regarding the fan blade, e.g., and without limitation, crack length data, surface wear data, radial deflection data, scrap rates and the like. Each of RMD data 210, design data 212, and inspection data 220 are in the form of various physical variables as mentioned. As such, operational temperature data takes the form of a temperature variable, crack length data takes the form of a length dimensional variable, scrap rates are measured in percentage and the like.

Cumulative model 214 issues a service life prediction 218. The predictions can take several forms including but not limited to deterministic output, probability density functions, probabilistic samples and the like. SLM computing device 10 processes prediction 218 and inspection data 220 using a likelihood function 222 that in turn generates a model parameter prior distribution 226 for each physical variable. Model parameter distribution 226 is, in one embodiment, a probability density function describing the relative likelihood of the physical variable having a particular value. One distribution is generated per physical constant per component per asset. If data from 20 engines are used to develop the service life decrease model, then 20 probability density functions will be generated for each physical constant (coefficient), e.g., for thermal effectiveness.

Model parameter prior distribution 226 is further refined using prior distributions 224. Prior distributions 224 represent expert knowledge of what values each physical variable is likely to have. This expert knowledge is introduced into the model by way of informative priors. For example, the range of each physical variable is tested against a prior knowledge of the possible maximum and minimum value for each physical variable. In one embodiment, SLM computing device 10 detects correlations between physical variables using the output of the likelihood function 222. For example, physical variables for operational temperature and thermal stress may be related such as temperature rises, so does thermal stress on the engine fan blade. Accordingly, likelihood function 222 will generate posterior distributions 226 that may show a high level of correlation between data for the two variables. SLM computing device 10 is configured to use posterior distributions 226 to generate an asset-specific model parameter distribution 228 for each physical variable. This model parameter distribution 228 will serve as a source of data points for a combined distribution that will be used to predict service life decrease in a target component, e.g., a new engine fan blade.

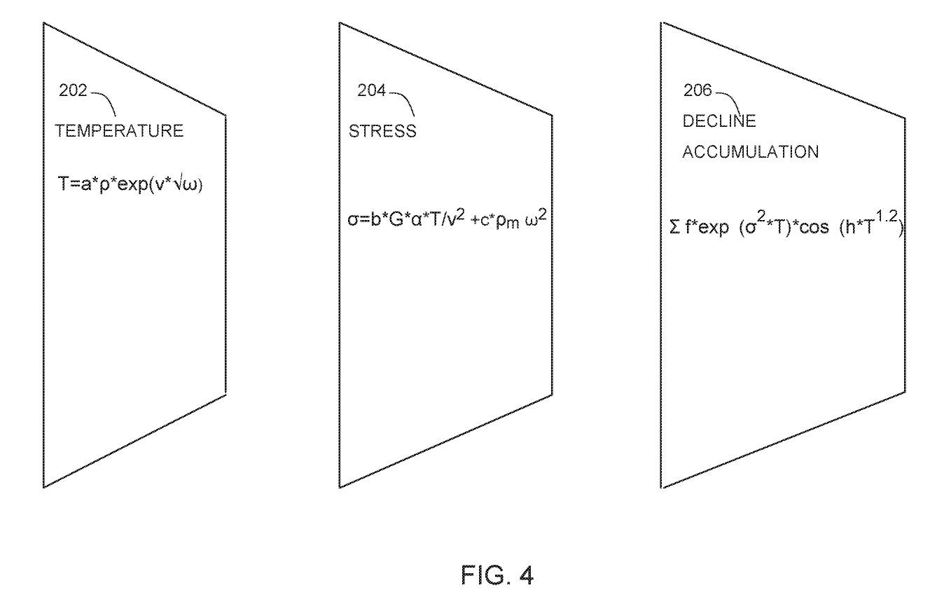

FIG. 4 is a flowchart of an exemplary method of combining multiple likelihood functions into a single model that is developed for a particular component, using SLM computing device 10 (shown in FIG. 1). In one embodiment, SLM computing device 10 receives component data from component testing computing devices 20 and feeds that component data into one or more probabilistic routines. For example, SLM computing device 10 takes temperature data for a component, e.g., temperature inside a running engine and input that into a temperature equation 202. SLM computing device 10 takes stress data for the component, e.g., shearing forces applied to engine fan blades and input that into a stress equation 204. SLM computing device 10 may take decline accumulation data for the component, e.g., crack length for a fan blade inside an engine and input that into a decline accumulation equation 206. For example, temperature could be related to air flow through an exponential law, e.g., T=α*ρ*exp(ν*√ω) and stresses can be a combination of centrifugal and thermal stresses given by

$$σ = b * G * α * \frac{T}{{v}^{2}} + c * {ρ}_{m} {ω}^{2} ,$$

service life decline could be related to stress and temperature by a cumulative model given by Σf*exp(σ²*T)*cos(h*T^{1.2}) where T is temperature, ρ and ρₘ represent density, ν is rotational velocity, ω is angular velocity, G is the gravitational constant, a is stress, a is a thermal constant, and a, b c, f and h are model coefficients that need to be estimated for each asset.

In one embodiment, SLM computing device 10 inputs data into its relevant equation to determine one or more coefficients. In FIG. 2, these are denoted by a, b, c, f and h. These coefficients may together be termed physical component data D. D is used to infer the probability distribution of unknown parameters in the service life model. In one embodiment, the timing of a certain event, e.g., and without limitation, a certain amount of decline in a component, a certain crack length in an engine, and the like, is an unknown value that will be predicted using the estimated coefficients a, b, c, f and g that could be thermal efficiency, stress concentration factors respectively. Accordingly, SLM computing device 10 generates a likelihood function of the unknown parameter (time) given the outcome D, i.e., the physical component data.

Using one or more likelihood functions as described above, SLM computing device 10 is configured to create one or more posterior probability density functions. These probability density functions are designed to generate priors for the coefficients a, b, c, f and h. In one embodiment, SLM computing device 10 is configured to input the priors into a Markov Chain Monte Carlo (MCMC) set of sampling algorithms. In one embodiment, SLM computing device 10 uses output from the sampling algorithms to generate predicted values for specific outcomes.

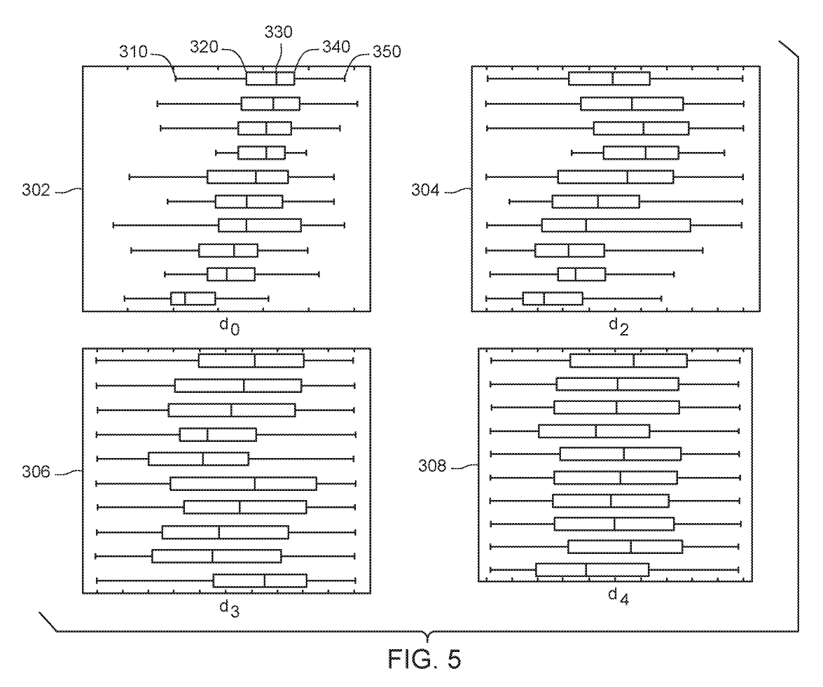

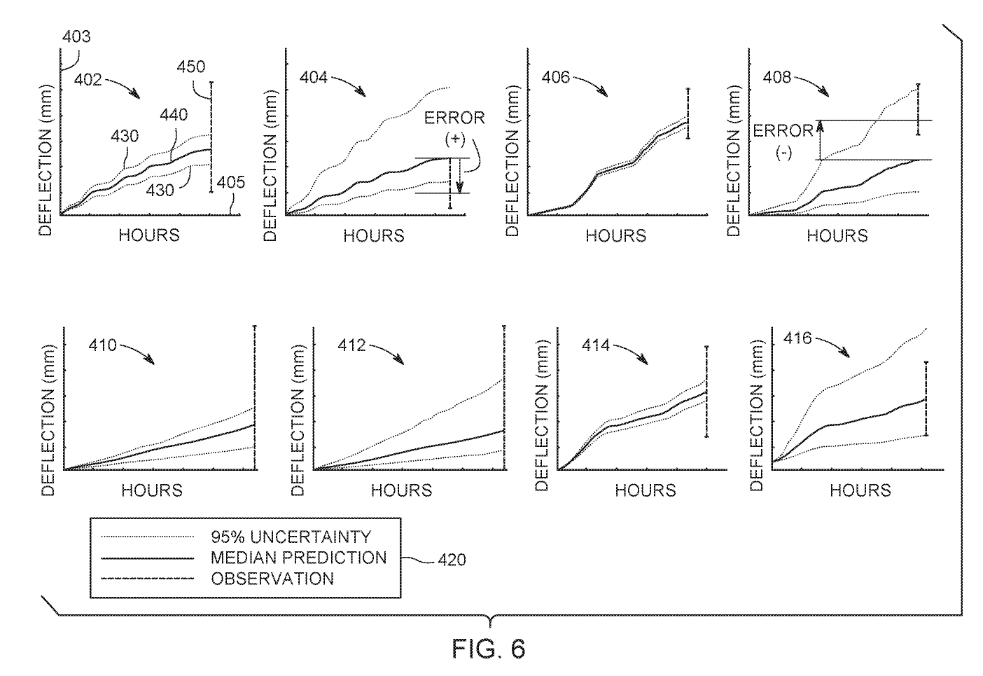

FIG. 5 illustrates a calibration process for a service life model using synthetic values for coefficients as received from a plurality of components. In one embodiment, these synthetic values are fed into the MCMC sampling algorithms in order to generate predicted values. As shown in graphs 302, 304, 306, and 308, a number of statistics are determined per coefficient for each component. As shown in graph 302, value 310 is the minimum value for a for the first component. Value 320 is the 25th percentile value for d₀ for the first component. Value 330 is the median value for a for the first component. Value 340 is the 75th percentile value for d₀ for the first component. Value 340 is the maximum value for a for the first component. Each of the other components in graph 302, has corresponding statistics calculated for a. Similarly, graphs 304, 306, and 308 show statistics calculated for b, c, f and h. Values for the coefficients are generated based on the synthetic values. Moreover, once predicted values are generated by the MCMC sampling algorithms, these predicted values are compared to actual values from test components that have undergone a comparable level of service life decline, in order to calibrate the model. For example, actual component data is received from an engine with significant decline in service life (a test component). This component data is compared to predicted life using the estimated coefficients are in the likelihood function. FIG. 6 shows a plurality of exemplary graphs illustrating prediction values for a component over time, using radial deflection in a component as an example data point. FIG. 6 includes a graph 402 that includes a unitless y-axis 403 representing deflection in millimeters and a unitless x-axis 405 showing time elapsed in hours. Graphs 404, 406, 408, 410, 412, 414, and 416 include y- and x-axes substantially comparable to y-axis 403 and x-axis 405 as included in graph 402. FIG. 6 also shows a key 420 denoting the meaning of the lines on each graph shown on FIG. 6. Graph 402 shows prediction values using a component's own data only. Graph 404 shows prediction values for the same component but after similarity analysis being performed on the component data using data from a plurality of other components that share at least one characteristic with the component. Together, 402 and 404 represent a “worst-case over-prediction” scenario.

Similarly, graph 406 shows prediction values using a component's own data only. Graph 408 shows prediction values for the same component but after similarity analysis being performed on the component data using data from a plurality of other components that share at least one characteristic with the component. Together, 406 and 408 represent a “worst-case under-prediction” scenario. Additionally, graph 410 shows prediction values using a component's own data only. Graph 412 shows prediction values for the same component but after similarity analysis being performed on the component data using data from a plurality of other components that share at least one characteristic with the component. Together, 410 and 412 represent a “best-case over-prediction” scenario. Graph 414 shows prediction values using a component's own data only. Graph 416 shows prediction values for the same component but after similarity analysis being performed on the component data using data from a plurality of other components that share at least one characteristic with the component. Together, 414 and 416 represent a “best-case under-prediction” scenario.

In graph 402, a pair of lines 430 represents the 95% zone of uncertainty for the predicted value, and line 440 represents the predicted value over time. Graphs 402, 404, 406, 408, 410, 412, 414, and 416 display lines substantially similar to lines 430 and 440. Point 450 on the vertical line represents the actual observed value for the turbine. As shown by the graphs, even in the worst-case scenarios of over-prediction or under-prediction, the systems and methods are able to predict the observed value with 95% certainty.

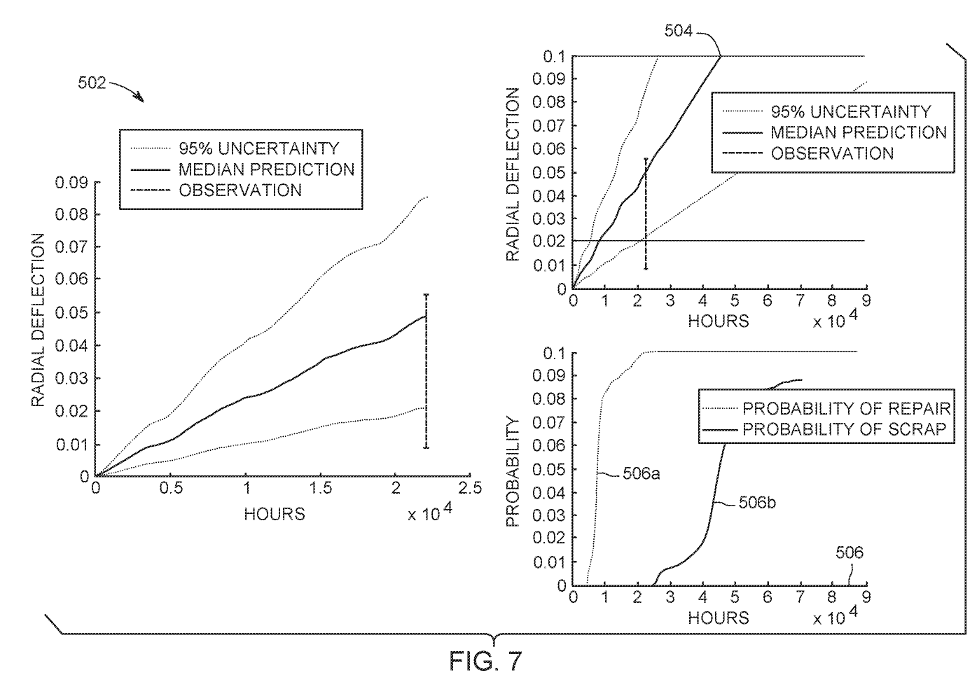

FIG. 7 shows a plurality of exemplary graphs illustrating future predictive values for a component. FIG. 7 shows not validation but the methods being applied to an actual component with service life decline. Graph 502 charts radial deflection in a component over time, with the upper and lower enclosing lines representing the 95% zone of uncertainty for the predicted value. The middle line represents the predicted value over time. The dot on the vertical line represents the actual observed value for the turbine. Graph 504 shows actual predictive values for the turbine with future use. In graph 504, predictive values are plotted on a continuous scale, showing the progression of the service life decline. Graph 504 also shows an actual observation using the dot on the vertical line, which is well within the 95% zone of uncertainty and follows the trend of service life decline plotted on the graph. Similarly, graph 506 illustrates probability of repair and scrap using lines 506a and 506b respectively. As shown, both probabilities inevitably approach 1 over time, but graph 506 is able to show the progression of both over time, showing distinct changes in trends, based on physical data received from the component that has been processed using the likelihood-function-based service-life model.

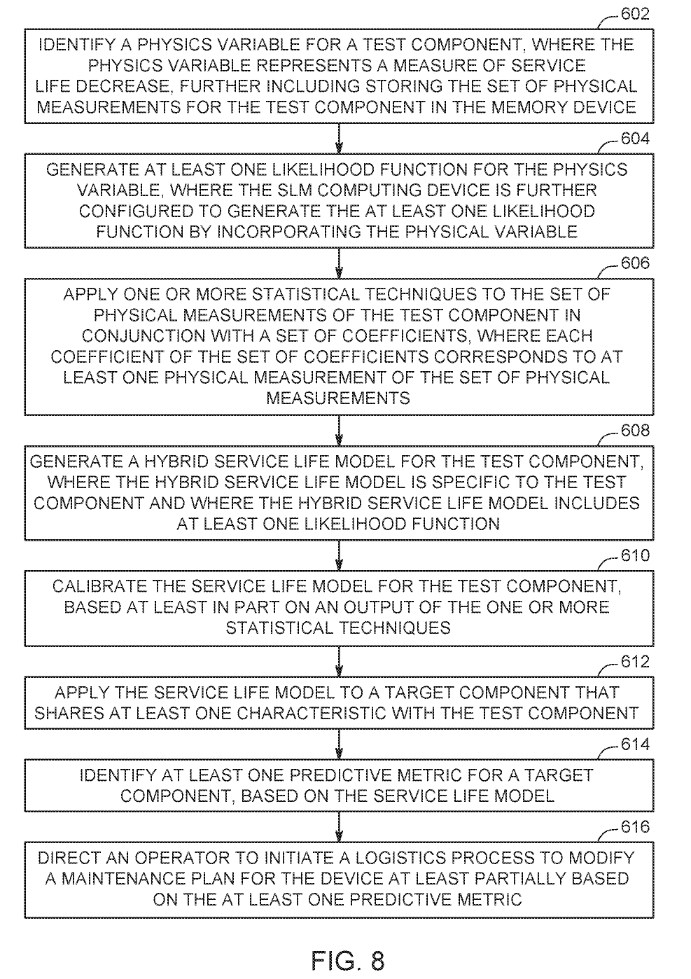

FIG. 8 shows an exemplary method for predicting decreases in a service life of components. SLM computing device 10 (shown in FIG. 1) identifies 602 a physics variable for a test component, where the physics variable represents a measure of service life decrease, further including storing a set of physical measurements for the test component in the memory device 134 (shown in FIG. 2). SLM computing device 10 generates 604 at least one likelihood function for the physics variable, where SLM computing device 10 is further configured to generate the at least one likelihood function by incorporating the physics variable. SLM computing device 10 applies 606 one or more probabilistic techniques to the set of physical measurements of the test component in conjunction with a set of coefficients, where each coefficient of the set of coefficients corresponds to at least one physical measurement of the set of physical measurements.

SLM computing device 10 generates 608 a hybrid service life model for the test component, where the hybrid service life model is specific to the test component and where the hybrid service life model includes the at least one likelihood function. SLM computing device 10 calibrates 610 the service life model for the test component, based at least in part on an output of the one or more probabilistic techniques, further including performing an individualized calibration for the test component. SLM computing device 10 applies 612 the service life model to a target component that shares at least one characteristic with the test component. SLM computing device 10 identifies 614 at least one predictive metric for a target component, based on the service life model. SLM computing device 10 directs 616 an operator to initiate a logistics process to modify a maintenance plan for the target component at least partially based on the at least one predictive metric. In one embodiment, an operator is any individual responsible for maintenance, supervision, or control of a target component. An operator may receive the direction at 616 via user interface coupled to SLM computing device 10. In another embodiment, the operator may operate a separate user computing device communicatively coupled to SLM computing device 10 and receive the direction at 616 via the user computing device or user interface connected to the user computing device. SLM computing device 10 is configured to issue the direction at 616 in a format compatible with an operator computing device.

In one embodiment, the logistics process may involve modifying a maintenance plan for the target component, or even removing the target component from service. The maintenance plan may be a computer-based process involving multiple defined steps geared to the target component, stored on computer-readable storage media. Accordingly, SLM computing device 10 may issue the direction at 616 in the form of an input to the computer-based maintenance plan. For example, the maintenance plan may be a usage-based lifing plan for a component involving automatically scheduled steps slated for the target component, e.g., accelerate use, change use of target component, observe blackout dates, perform maintenance during maintenance dates, etc. The direction at 616 is configured to cause the maintenance plan, e.g., running on an operator computer device or even a computing device connected to the target component itself, to change in light of the direction. For example, where significant service life decrease is indicated, the direction at 616 may be to remove the target component from service entirely. In such a case, while the maintenance plan may be to issue computer-based instructions to continue use of the target component, the direction at 616 will automatically modify the maintenance plan to terminate, e.g., at a scheduled date, and notify all affected users, e.g., via electronic alerts, that the target component is or will be out of service at a scheduled date. The direction at 616 may further direct a target component computing device to disconnect from other computing devices or components in light of the direction to terminate service life of the target component.

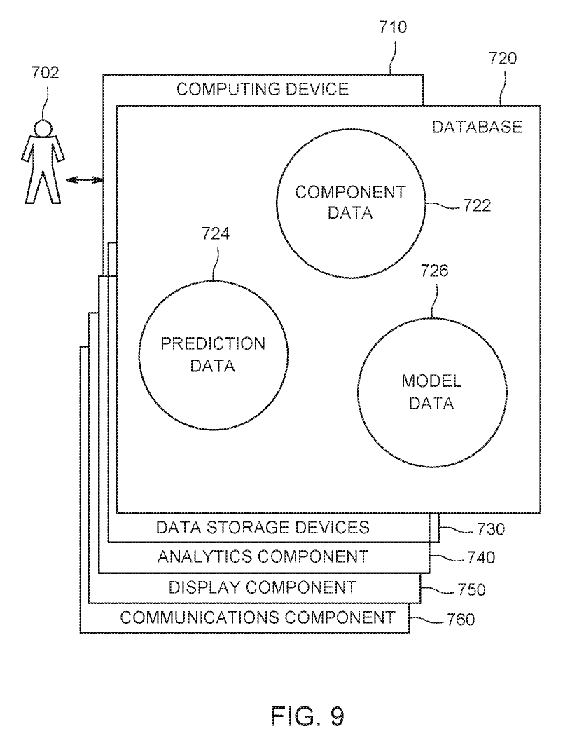

FIG. 9 is an exemplary configuration of a database within SLM computing device 10 (shown in FIG. 1), along with other related computing components, that are used to predict service life decrease in a component. In some embodiments, computing device 710 is similar to SLM computing device 10. User 702 (such as an owner of a component) accesses computing device 710 in order to predict the service life decrease for a component. In some embodiments, database 720 is similar to storage device 134 (shown in FIG. 1). In the exemplary embodiment, database 720 includes component data 722, prediction data 724, and model data 726. Component data 722 includes data regarding each component, e.g., and without limitation, component identifiers, service life stage, component owner(s), associated service model identifier, and the like. Prediction data 724 includes data about predictions for each component, e.g., and without limitation, predicted repair date, predicted scrap date, probability density functions, and the like. Model data 726 includes likelihood function data, component testing data, calibration data, and the like.

Computing device 710 also includes data storage devices 730. Computing device 710 also includes analytics component 740 that processes component data received from various component testing computing devices and from user computing devices at least in order to generate service life models. Computing device 710 also includes display component 750 that receives prediction data from analytics component 740 and converts it into various formats in order to provide predictions compatible with a variety of user computing devices. Computing device 710 also includes communications component 760 which is used to communicate with user computing devices and component test computing devices using predefined network protocols such as TCP/IP (Transmission Control Protocol/Internet Protocol) over the Internet.

The methods and systems described herein may be implemented using computer programming or engineering techniques including computer software, firmware, hardware, or any combination or subset thereof, where the technical effects may be achieved by performing at least one of the following steps: (a) identifying, by the SLM computing device, a physics variable for a test component, where the physics variable represents a measure of service life decrease, further including storing a set of physical measurements for the test component in the memory device, (b) generating, by the SLM computing device, at least one likelihood function for the physics variable, where the SLM computing device is further configured to generate the at least one likelihood function by incorporating the physics variable and coefficients, (c) applying, by the SLM computing device, one or more probabilistic techniques to the set of physical measurements of the test component in conjunction with a set of coefficients, where each coefficient of the set of coefficients corresponds to at least one physical measurement of the set of physical measurements, (d) generating, by the SLM computing device, a hybrid service life model for the test component per asset, where the hybrid service life model is specific to the test component and where the hybrid service life model includes the at least one likelihood function, (e) calibrating, by the SLM computing device, the service life model for the test component, based at least in part on an output of the one or more probabilistic techniques, further including performing an individualized calibration for the test component, (f) applying, by the SLM computing device, the service life model to a target component that shares at least one characteristic with the test component, (g) identifying, by the SLM computing device, least one predictive metric for a target component, based on the service life model, (h) outputting the at least one predictive metric, and (i) directing, by the SLM computing device, an operator to initiate a logistics process to modify a maintenance plan for the target component and asset at least partially based on the at least one predictive metric.

The above-described service life decrease modeling systems and methods overcome a number of deficiencies associated with known systems and methods of modeling service life decrease. Specifically, the above-described systems and methods enable an individualized modeling for each operational component that is then applied to a target component whose future service life is to be modeled. Unlike some known methods, each operational component and asset is individually modeled, and probability distributions predicting future values for multiple physical variables are processed by a service life modeling computer device that then predicts service life decrease for a target component at an asset specific level, e.g., a new component.

An exemplary technical effect of the methods, systems, and apparatus described herein includes at least one of: (i) enabling built-in model quality assessment, allowing a service life decrease model to be calibrated and updated dynamically; (ii) ability to quantify how inaccurate or uncertain the model is; (iii) ability to determine how predicted service life decrease is impacted if values for specific variables (e.g., physical data) are altered; (iv) a scalable model that can be deployed to large fleets due to computational efficiency; (v) accurately predicting service life decrease even for a newer component with little or no operational history; and (vi) predicting trends in service life decrease, e.g., time intervals in which service life decrease is higher or lower than other time intervals. Moreover, unlike traditional models that can be updated only when new failure data is observed, these asset specific hybrid physics models constantly evolve with only operational data as input. This is a huge benefit compared to the state-of-the-art methods in use today.

Exemplary embodiments of service life modeling computer systems for modeling service life decrease in a component are described above in detail. The service life modeling computer systems, and methods of operating such systems are not limited to the specific embodiments described herein, but rather, components of systems and/or steps of the methods may be utilized independently and separately from other components and/or steps described herein. For example, the systems and methods may also be used in combination with other systems requiring modeling of service life decrease for a component, and are not limited to practice with only the facilities, systems and methods as described herein. Rather, the exemplary embodiment can be implemented and utilized in connection with many other modeling applications that are configured to model and predict service life decrease for a component.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for determining a decrease in service life to a target component, said system comprising a service life modeling (SLM) computing device in communication with a memory device and a processor, said SLM computing device configured to:
identify a physics variable for a test component, wherein the physics variable represents a measure of service life decrease;
store a set of physical measurements for the test component in said memory device;
generate at least one likelihood function for the physics variable incorporating the physics variable;
apply one or more probabilistic techniques to the set of physical measurements of the test component in conjunction with a set of coefficients, wherein each coefficient of the set of coefficients corresponds to at least one physical measurement of the set of physical measurements;
generate a hybrid service life model for the test component, wherein the hybrid service life model is specific to the test component and wherein the hybrid service life model includes the at least one likelihood function;
calibrate the hybrid service life model for the test component based at least in part on the application of the one or more probabilistic techniques;
apply the hybrid service life model to the target component that shares at least one characteristic with the test component;
identify at least one predictive metric for the target component, based on the service life model; and
direct an operator to initiate a logistics process that modifies a maintenance plan for the target component at least partially based on the at least one predictive metric.

2. The system in accordance with claim 1, wherein the service life model is one of a plurality of service life models, and wherein said SLM computing device further configured to hybridize the service life model with at least one other service life model to identify the predictive metric.

3. The system in accordance with claim 1, wherein said SLM computing device further configured to apply the one or more probabilistic techniques using a hybrid physics-based framework, wherein the one or more probabilistic techniques include Bayesian inference.

4. The system in accordance with claim 1, wherein the one or more probabilistic techniques include Gaussian mixture modeling, Metropolis-within-Gibbs sampling (MWGS), and a Markov-Chain-Monte-Carlo (MCMC) method.

5. The system in accordance with claim 1, wherein, to calibrate the hybrid service life model, said SLM computing device further configured to generate synthetic values for the set of coefficients from at least one other test component, including using at least one synthetic value for input into the service life model.

6. The system in accordance with claim 5, wherein, to calibrate the hybrid service life model, said SLM computing device further configured to compare, using similarity analysis, the output from the one or more probabilistic techniques for the test component with the output for at least one other test component.

7. The system in accordance with claim 1, wherein, to output the at least one predictive metric, said SLM computing device further configured to output a probability distribution for the set of coefficients.

8. A method for determining a decrease in service life to a target component, said method implemented using a service life modeling (SLM) computing device in communication with a memory device and a processor, said method comprising:
identifying, by the SLM computing device, a physics variable for a test component, wherein the physics variable represents a measure of service life decrease;
storing a set of physical measurements for the test component in said memory device;
generating, by the SLM computing device, at least one likelihood function incorporating the physics variable;
applying, by the SLM computing device, one or more probabilistic techniques to the set of physical measurements of the test component in conjunction with a set of coefficients, wherein each coefficient of the set of coefficients corresponds to at least one physical constant of the set of physical measurements;
generating, by the SLM computing device, a hybrid service life model for the test component, wherein the hybrid service life model is specific to the test component and wherein the hybrid service life model includes the at least one likelihood function;
calibrating, by the SLM computing device, the service life model for the test component based at least in part on an output of the one or more probabilistic techniques applying, by the SLM computing device, the service life model to a target component that shares at least one characteristic with the test component;
identifying, by the SLM computing device, least one predictive metric for the target component, based on the service life model; and
directing, by the SLM computing device, an operator to initiate a logistics process to modify a maintenance plan for the target component at least partially based on the at least one predictive metric.

9. The method in accordance with claim 8, wherein the service life model is one of a plurality of service life models, said method further comprising hybridizing the service life model with at least one other service life model to identify the predictive metric.

10. The method in accordance with claim 8, further comprising applying the one or more probabilistic techniques using a hybrid physics-based Bayesian inference framework.

11. The method in accordance with claim 8, wherein the one or more probabilistic techniques include Gaussian mixture modeling, Metropolis-within-Gibbs sampling (MWGS), and a Markov-Chain-Monte-Carlo (MCMC) method.

12. The method in accordance with claim 8, wherein calibrating the hybrid service life model comprises generating synthetic values for the set of coefficients from at least one other test component, comprising using at least one synthetic value for input into the service life model.

13. The method in accordance with claim 8, wherein calibrating the hybrid service life model further comprises comparing, using similarity analysis, the output from the one or more probabilistic techniques for the test component with the output for at least one other test component.

14. The method in accordance with claim 8, wherein outputting the at least one predictive metric further comprises outputting a probability distribution for the set of coefficients.

15. A computer readable medium having computer-executable instructions embodied thereon for determining a decrease in service life to a target component, wherein when executed by at least one processor, the computer-executable instructions cause the at least one processor to:
identify a physics variable for a test component, wherein the physics variable represents a measure of service life decrease;
store a set of physical measurements for the test component within a memory device coupled to the at least one processor;
generate at least one likelihood function for the physics variable, wherein the at least one processor is further configured to generate the at least one likelihood function by incorporating the physics variable;
apply one or more probabilistic techniques to the set of physical measurements of the test component in conjunction with a set of coefficients, wherein each coefficient of the set of coefficients corresponds to at least one physical measurement of the set of physical measurements;
generate a hybrid service life model for the test component, wherein the hybrid service life model is specific to the test component and wherein the hybrid service life model includes the at least one likelihood function;
calibrate the hybrid service life model for the test component, based at least in part on an output of the one or more probabilistic techniques;
apply the hybrid service life model to a target component that shares at least one characteristic with the test component;
identify at least one predictive metric for a target component, based on the service life model; and
direct an operator to initiate a logistics process to modify a maintenance plan for the target component at least partially based on the at least one predictive metric.

16. The computer readable medium in accordance with claim 15, wherein the service life model is one of a plurality of service life models, and wherein the computer-executable instructions further cause the at least one processor to hybridize the service life model with at least one other service life model to identify the predictive metric.

17. The computer readable medium in accordance with claim 15, wherein the computer-executable instructions further cause the at least one processor to apply the one or more probabilistic techniques using a hybrid physics-based Bayesian inference framework.

18. The computer readable medium in accordance with claim 15, wherein the one or more probabilistic techniques include Gaussian mixture modeling, Metropolis-within-Gibbs sampling (MWGS), and a Markov-Chain-Monte-Carlo (MCMC) method.

19. The computer readable medium in accordance with claim 15, wherein the computer-executable instructions further cause the at least one processor to generate synthetic values for the set of coefficients from at least one other test component, including using at least one synthetic value for input into the service life model.

20. The computer readable medium in accordance with claim 15, wherein the computer-executable instructions further cause the at least one processor to compare, using similarity analysis, the output from the one or more probabilistic techniques for the test component with the output for at least one other test component.

21. The computer readable medium in accordance with claim 15, wherein the computer-executable instructions further cause the at least one processor to output a probability distribution for the set of coefficients.
